(19) United States
(12) Patent Application Publication
(10) Pub. No.: US 2026/0230422 A1
(43) Pub. Date: Aug. 6, 2026

(54) MULTI-PATH SECURE DATA TRANSMISSION SYSTEM AND METHOD OF USE

(71) Applicant: Mike Hamilton, Hudson, OH (US)

(72) Inventor: Mike Hamilton, Hudson, OH (US)

(21) Appl. No.: 19/529,839

(22) Filed: Feb. 4, 2026

Related U.S. Application Data
(60) Provisional application No. 63/753,573, filed on Feb. 4, 2025.

(51) Int. Cl. H04L 45/24; H04W 24/08

(52) U.S. Cl. CPC H04L 45/24; H04W 24/08

(57) ABSTRACT

A system and method for secure multipath data transmission is disclosed. A transmitting device identifies multiple physical network interfaces, each associated with a distinct public IP address, and assigns a virtual logical IP address to provide a unified communication endpoint with a receiving device. Application layer data is translated into packets and fragmented into multiple independent data splits using an artificial intelligence (AI) efficiency algorithm that dynamically determines fragmentation ratios based on real-time network path conditions. The independent data splits are transmitted concurrently across the multiple physical network interfaces and received at the receiving device, where the multiple independent data splits are reassembled into the original data stream for delivery to an application layer. The artificial intelligence (AI) efficiency algorithm can further provide temporal obfuscation by modifying timestamps of the individual data splits and coordinate fragment sequencing and error correction.

### CROSS-REFERENCE TO RELATED APPLICATION

The present application claims priority to, and the benefit of, U.S. Provisional Application No. 63/753,573 which was filed on Feb. 4, 2025 and is incorporated herein by reference in its entirety.

### FIELD OF THE INVENTION

The present invention generally relates to data communication systems. More specifically, the present invention relates to a multi-path secure data transmission system configured to simultaneously utilize multiple physical network interfaces of a device to increase bandwidth, improve reliability, and enhance communication security. The invention comprises a multi-component communication architecture including command and control software, a multipath and fragmentation engine, and a logical IP addressing layer operating on both a transmitting device and a receiving device. Application layer data is fragmented into multiple independent data splits and distributed concurrently across multiple physical network interfaces using different public IP addresses. A virtual logical IP address is assigned to each device to provide a unified communication endpoint independent of physical network addressing. In certain embodiments, an artificial intelligence (AI) efficiency optimization engine dynamically determines fragmentation ratios, transmission paths, and timing offsets for individual data splits based on real-time network conditions. The system can further provide temporal obfuscation and coordinated reassembly of fragments to enhance resistance to interception and traffic analysis. Accordingly, this disclosure makes specific reference thereto. Nonetheless, it is to be appreciated that aspects of the present invention are also equally applicable to other like applications, devices, and methods of manufacture.

### BACKGROUND

By way of background, modern digital infrastructure increasingly relies on high-speed, packet-switched networks to support a wide range of applications including cloud computing, real-time communications, streaming media, financial transactions, and Internet-of-Things (IOT) services. As reliance on digital communications continues to grow, challenges remain with respect to user anonymity, data security, reliability, and performance.

Traditional data transmission techniques commonly utilize a single network path and a single public IP address between communicating devices. Such single-path transmissions are inherently susceptible to interception, monitoring, and traffic analysis by unauthorized parties. Even when encryption is employed, metadata associated with single-path communication, such as timing patterns, packet sizes, and source and destination addresses, can reveal sensitive information regarding user behavior and communication relationships.

Additionally, single-path transmission architectures are constrained by the bandwidth, latency, and reliability characteristics of a single physical network interface. Many modern computing devices are equipped with multiple network interfaces, such as Wi-Fi, cellular, Ethernet, and short-range wireless radios, yet conventional networking stacks typically utilize only one interface at a time for application layer communication. As a result, the aggregate bandwidth potential of multi-connected devices remains largely underutilized.

Attempts to improve performance through load balancing, virtual private networks, or multi-homing techniques have achieved limited success and often introduce additional complexity, latency, or centralized points of failure. Furthermore, such approaches generally do not provide inherent protection against traffic correlation or interception across multiple independent networks

Therefore, there exists a long-felt need in the art for an improved data transmission system that overcomes the limitations of conventional single-path network communications. There is a long-felt need for a transmission architecture that simultaneously utilizes multiple physical network interfaces of a device to increase effective bandwidth and improve reliability. Additionally, there exists a need for a communication system that enhances user privacy and resistance to interception without relying solely on encryption or centralized tunneling services. Moreover, there is a need for a solution that remains transparent to existing applications and does not require modification of application layer software. Finally, there is a need for a data transmission system that dynamically adapts to changing network conditions while maintaining continuous sessions and consistent addressing.

The subject matter disclosed and claimed herein, in one embodiment, comprises a multi-path secure data transmission system configured to provide simultaneous utilization of multiple physical network interfaces on a device. The system includes a transmitting device and a receiving device, each having command and control software and a multipath and fragmentation engine. A virtual logical IP address is assigned to each device to provide a unified communication endpoint independent of physical network interfaces. Application layer data is fragmented into multiple independent data splits and transmitted concurrently across the multiple physical network interfaces using different public IP addresses.

In one embodiment, the system further includes an artificial intelligence (AI) efficiency optimization engine configured to analyze real-time network conditions and dynamically determine fragmentation ratios, transmission paths, and timing offsets for individual data splits. The artificial intelligence (AI) efficiency optimization engine can further modify timestamps associated with individual data splits to provide temporal obfuscation and coordinate fragment sequencing and error correction between the transmitting device and the receiving device.

In this manner, the multi-path secure data transmission system of the present invention overcomes long-standing deficiencies in the art by aggregating bandwidth from multiple interfaces, improving reliability, and providing enhanced resistance to interception and traffic analysis. The invention enables session continuity, improved performance, and increased privacy while remaining compatible with existing network infrastructure and applications. As a result, the invention provides a scalable, efficient, and secure communication framework for modern multi-connected computing devices.

The invention provides a unique method for optimizing data transmission, enhancing security and performance by fragmenting IP packets and distributing them across multiple physical network paths. The invention creates an “obfuscation layer” making it difficult for bad actors to intercept a complete data stream because the information is never transmitted in its entirety over a single connection.

By assigning a virtual “Logical Device IP” to a multi-connected device, the system creates a unified endpoint that masks the underlying physical connections. The “Split State” approach ensures that no single network path carries the complete data stream, thereby obfuscating the information and making it difficult for unauthorized actors to intercept the full communication.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-path secure data transmission system. The system comprises a transmitting device, a receiving device, and an artificial intelligence (AI) efficiency optimization engine. The transmitting device comprises at least one processor and a plurality of physical network interfaces, each physical network interface being associated with a distinct physical network connection and a corresponding public IP address. The transmitting device further comprises command and control software and a multipath and fragmentation engine executed by the at least one processor. The receiving device comprises at least one processor and a plurality of physical network interfaces, command and control software, and a multipath and fragmentation engine. The command and control software assigns a logical IP address to the transmitting device and the receiving device to provide a unified communication endpoint. The multipath and fragmentation engine of the transmitting device fragments application layer data into a plurality of independent data splits. The artificial intelligence (AI) efficiency optimization engine analyzes network conditions and determines fragmentation ratios, transmission paths, and timing offsets for the plurality of independent data splits. The transmitting device transmits the plurality of independent data splits concurrently across the plurality of physical network interfaces using different public IP addresses. The multipath and fragmentation engine of the receiving device receives the plurality of independent data splits from the plurality of physical network interfaces and reassembles the plurality of independent data splits into an original data stream.

In one aspect, a method for secure multipath data transmission is provided. The method comprises identifying at least two distinct physical network interfaces on a transmitting device, each physical network interface being associated with a unique public IP address. A virtual logical IP address is assigned to the transmitting device and to a corresponding receiving device to serve as a unified communication endpoint. An application layer message is translated into a plurality of data packets. An artificial intelligence (AI) efficiency algorithm is utilized to fragment the data packets into multiple splits, wherein a ratio of fragmentation is dynamically determined based on real-time network path quality. The multiple splits are transmitted concurrently across the identified physical network interfaces. The multiple splits are received at the receiving device and reassembled into the original data packets for delivery to an application layer.

In one embodiment, the artificial intelligence (AI) efficiency algorithm is synchronized between the transmitting device and the receiving device to coordinate fragment sequencing and error correction.

In yet another embodiment, the artificial intelligence (AI) efficiency algorithm dynamically modifies timestamps associated with individual splits prior to transmission to provide temporal obfuscation and to prevent chronological reassembly by unauthorized interceptors.

In another embodiment, a method for secure multi-path data transmission is provided. The method comprises identifying a plurality of physical network interfaces on a transmitting device. The method further comprises assigning a logical IP address to the transmitting device as a unified communication endpoint. Application layer data is translated into packets. Network conditions are analyzed using an artificial intelligence (AI) efficiency optimization engine. The packets are fragmented into a plurality of independent data splits based on the analyzed network conditions. Timestamps associated with the plurality of independent data splits are randomized to provide temporal obfuscation. The plurality of independent data splits are transmitted concurrently across the plurality of physical network interfaces using different public IP addresses.

In a further embodiment, a method for reconstructing a secure multi-path data stream is provided. The method comprises receiving, at a receiving device, a plurality of independent data splits via a plurality of physical network interfaces. Fragment identifiers and sequence metadata are extracted from the plurality of independent data splits. The plurality of independent data splits are reordered based on the sequence metadata. Error correction is performed on the plurality of independent data splits. The plurality of independent data splits are reassembled into an original data stream. The original data stream is delivered to an application layer via a logical IP address.

In still another embodiment, a non-transitory computer-readable medium stores instructions that, when executed by one or more processors of a transmitting device, cause the one or more processors to perform operations. The operations comprise identifying a plurality of physical network interfaces. The operations further comprise assigning a logical IP address to the transmitting device as a unified communication endpoint. Application layer data is translated into packets. Network conditions are analyzed using an artificial intelligence (AI) efficiency optimization engine. The packets are fragmented into a plurality of independent data splits based on the analyzed network conditions. Timestamps associated with the plurality of independent data splits are randomized. The plurality of independent data splits are transmitted concurrently across the plurality of physical network interfaces using different public IP addresses.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a block architecture diagram of multi-path secure data transmission system of the present invention in accordance with the disclosed structure;

FIG. 2 illustrates a block diagram showing internal functional components installed in a device configured for use in the multi-path secure data transmission system of the present invention, in accordance with the disclosed architecture;

FIG. 3 illustrates a functional block diagram showing artificial intelligence driven data split efficiency optimization process performed in the multi-path secure data transmission system of the present invention, in accordance with the disclosed architecture;

FIG. 4 illustrates a functional block diagram showing artificial intelligence driven temporal obfuscation and timestamp randomization applied to data splits in accordance with the disclosed structure;

FIG. 5 illustrates a flowchart showing steps for establishing multipath connectivity and initiating secure multi-path data transmission between devices using the multi-path secure data transmission system of the present invention;

FIG. 6 illustrates a flowchart showing steps for artificial intelligence driven data splitting and temporal obfuscation in accordance with the disclosed structure; and

FIG. 7 illustrates a functional sequence diagram showing multipath data transmission and reassembly process between the transmitting device and the receiving device in accordance with the one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long-felt need in the art for an improved data transmission system that overcomes the limitations of conventional single-path network communications. There is a long-felt need for a transmission architecture that simultaneously utilizes multiple physical network interfaces of a device to increase effective bandwidth and improve reliability. Additionally, there exists a need for a communication system that enhances user privacy and resistance to interception without relying solely on encryption or centralized tunneling services. Moreover, there is a need for a solution that remains transparent to existing applications and does not require modification of application layer software. Finally, there is a need for a data transmission system that dynamically adapts to changing network conditions while maintaining continuous sessions and consistent addressing.

The present invention, in one exemplary embodiment, is a method for secure multipath data transmission. The method comprises identifying at least two distinct physical network interfaces on a transmitting device, each physical network interface being associated with a unique public IP address. A virtual logical IP address is assigned to the transmitting device and to a corresponding receiving device to serve as a unified communication endpoint. An application layer message is translated into a plurality of data packets. An artificial intelligence (AI) efficiency algorithm is utilized to fragment the data packets into multiple splits, wherein a ratio of fragmentation is dynamically determined based on real-time network path quality. The multiple splits are transmitted concurrently across the identified physical network interfaces. The multiple splits are received at the receiving device and reassembled into the original data packets for delivery to an application layer.

Reference will now be made in detail to the present preferred embodiments of the invention, examples of which are illustrated in the accompanying drawings. Wherever possible, the same reference numerals are used in the drawings and the description to refer to the same or like parts.

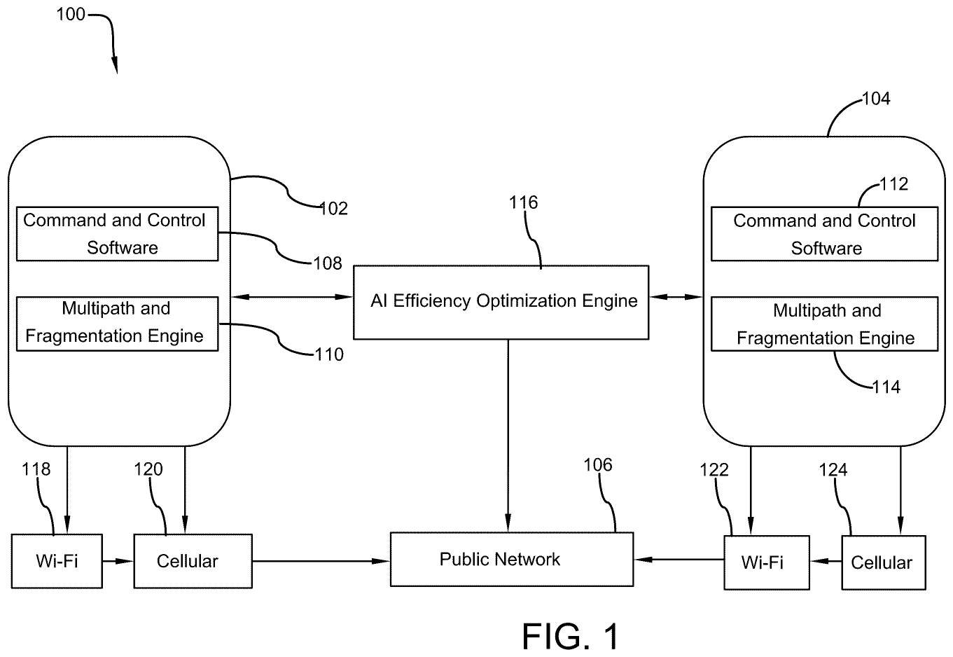

Referring initially to the drawings, FIG. 1 illustrates a block architecture diagram of multi-path secure data transmission system of the present invention in accordance with the disclosed structure. The multi-path secure data transmission system 100 of the present invention is configured as a system for simultaneously utilizing a plurality of physical network interfaces on a device to increase bandwidth, improve reliability, and enhance security through packet fragmentation, logical addressing, and artificial intelligence driven optimization.

More specifically, the multi-path secure data transmission system 100 includes a transmitting device 102 and a receiving device 104 that are configured to communicate across a public network 106. The transmitting device 102 includes command and control software 108 and a multipath and fragmentation engine 110. The receiving device 104 similarly includes corresponding command and control software 112 and a multipath and fragmentation engine 114. In the illustrated embodiment, an artificial intelligence (AI) efficiency optimization engine 116 is communicatively coupled between the transmitting device 102 and the receiving device 104 and is configured to coordinate fragmentation ratios, path selection, temporal obfuscation, and error handling logic between the respective devices, as described later in the disclosure.

The command and control software 108 and 112 is configured to manage device identification of the corresponding device, session establishment, and coordination of multipath communications. The command and control software further interfaces with the multipath and fragmentation engines 110 and 114 to control packet splitting, encapsulation, sequencing, and reassembly operations. The multipath and fragmentation engine 110 of the transmitting device 102 is configured to fragment outgoing data into multiple independent data splits and distribute the data splits across multiple physical network interfaces 118 and 120.

The transmitting device 102 includes a Wi-Fi interface 118 and a cellular interface 120. Each interface is associated with a distinct physical network connection and a corresponding public IP address for secure transmission with the receiving device 104.

The multipath and fragmentation engine 114 of the receiving device 104 is configured to receive fragmented data splits from multiple network interfaces and to reassemble the data splits into an original data stream. The receiving device 104 includes a Wi-Fi interface 122 and a cellular interface 124 for providing independent connectivity to the public network 106.

The artificial intelligence (AI) efficiency optimization engine 116 is configured to analyze real-time network conditions including latency, bandwidth, packet loss, and jitter and to dynamically determine fragmentation ratios, transmission paths, and timing offsets for individual data splits. The artificial intelligence (AI) efficiency optimization engine 116 is further configured to apply temporal obfuscation by modifying timestamps associated with individual data splits prior to transmission and to provide synchronization information to both the transmitting device 102 and the receiving device 104 to enable coordinated reassembly.

The public network 106 can comprise one or more external networks including, but not limited to, the Internet, carrier core networks, or other packet-switched networks over which fragmented data splits are transmitted. Data splits originating from the Wi-Fi interface 118 and cellular interface 120 of the transmitting device 102 can traverse the public network 106 and be received by either the Wi-Fi interface 122 or cellular interface 124 of the receiving device 104.

In operation, application layer data generated at the transmitting device 102 is processed by the command and control software 108 and fragmented by the multipath and fragmentation engine 110. The resulting data splits are transmitted concurrently via the Wi-Fi interface 118 and the cellular interface 120 over the public network 106. The receiving device 104 receives the data splits through one or more of its network interfaces 122 and 124, and the multipath and fragmentation engine 114 reconstructs the original data stream under coordination of the command and control software 112 and the artificial intelligence (AI) efficiency optimization engine 116.

In one embodiment, each of the transmitting device 102 and the receiving device 104 can be configured as a programmable computing device to execute instructions stored in memory and to communicate via multiple physical network interfaces. The devices can be implemented as, without limitation, a smartphone, tablet computer, laptop computer, desktop computer, server, gateway, router, embedded system, Internet of Things device, edge computing node, or any combination thereof.

In some embodiments, the command and control software 108, 112 and the multipath and fragmentation engines 110, 114 can be implemented as one or more software modules executed by one or more processors. In other embodiments, one or more portions of such modules can be implemented in firmware or dedicated hardware. The modules may operate in user space, kernel space, or a combination thereof, and can be integrated within a single application, distributed across multiple applications or services, or embedded within the operating system networking stack.

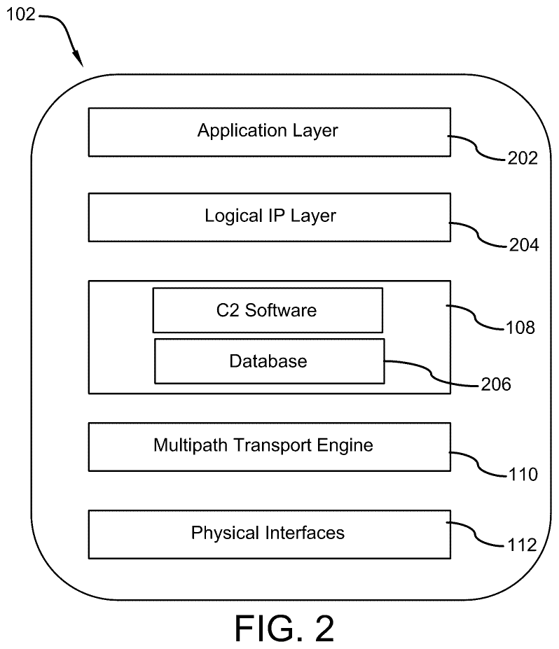

FIG. 2 illustrates a block diagram showing internal functional components installed in a device configured for use in the multi-path secure data transmission system of the present invention, in accordance with the disclosed architecture. In the present embodiment, the transmitting device 102 is shown as the exemplary device but it should be noted that the receiving device 104 (FIG. 1) can have the same components therein.

An application layer 202 comprises one or more software applications or services executing on transmitting device 102 that generate, transmit, receive, and consume application layer data. The application layer 202 can include web browser, messaging application, voice-over-IP application, video streaming applications, or any other enterprise software applications.

The application layer 202 is configured to interface with the logical IP layer 204 and utilizes a virtual logical IP address assigned to the transmitting device 102 as a unified communication endpoint. All network communications of the application layer 202 logically occur over a single logical network connection, regardless of the number or type of underlying physical network interfaces used by the device.

In operation, application layer data generated by the application layer 202 is provided to the logical IP layer 204, which forwards the data to the command and control software 108 and the multipath transport engine 110 for fragmentation, scheduling, and transmission. Similarly, reassembled data received by the multipath transport engine 110 is delivered through the logical IP layer 204 to the application layer 202 in its original format.

The logical IP layer 204 is configured to assign and maintain a virtual private logical IP address for the transmitting device 102 that serves as a unified communication endpoint. The logical IP layer 204 is configured to decouple application layer sessions from physical network addressing and enables session persistence even when underlying physical network interfaces change.

The command and control software 108 as described in FIG. 1 operates as an orchestration layer for the transmitting device 102 and is configured to manage device identification, authentication, session establishment, logical IP assignment, and coordination of multipath communications. Preferably, the command and control software 108 further includes or is communicatively coupled to a database 206.

The database 206 stores device and network information including, but not limited to, MAC addresses associated with physical interfaces, public IP addresses, and logical IP mappings. The database 206 enables rapid lookup and synchronization of information used for multipath transmission and reassembly.

The device and network database 206 comprises one or more data repositories accessible by the command and control software 108 and configured to store, maintain, and provide information used for multipath secure data transmission. The database 206 can be implemented using any suitable storage technology including, but not limited to, relational databases, key-value stores, object stores, graph databases, flat files, or combinations thereof.

The database 206 maintains a mapping between logical IP addresses and corresponding physical network interface identifiers, MAC addresses, and public IP addresses. This mapping enables the system to present a unified logical communication endpoint to the application layer while internally managing multiple concurrent physical connections.

The database 206 can be implemented as a local database residing on the transmitting device 102. In other embodiments, the database 206 can be distributed across a plurality of devices or synchronized with a remote database or service. During operation, the command and control software 108 queries the database 206 to retrieve device and network information prior to establishing multipath sessions and updates the database 206 as network conditions change.

The physical interfaces represent a plurality of network interface devices including, but not limited to, Wi-Fi interfaces, cellular interfaces, Ethernet interfaces, Bluetooth interfaces, near-field communication interfaces, and other wired or wireless communication interfaces. Each physical interface is associated with a distinct physical network connection and is assigned a unique MAC address and public IP address.

In operation, application layer data generated by the application layer 202 is provided to the logical IP layer 204 and then processed by the command and control software 108 and the multipath transport engine 110. The data is fragmented and transmitted concurrently across the physical interfaces 118 and 120. Incoming fragmented data received via the physical interfaces is processed by the multipath transport engine 110 and coordinated by the command and control software 108 to reassemble the original data stream and deliver the reassembled data to the application layer 202 via the logical IP layer 204.

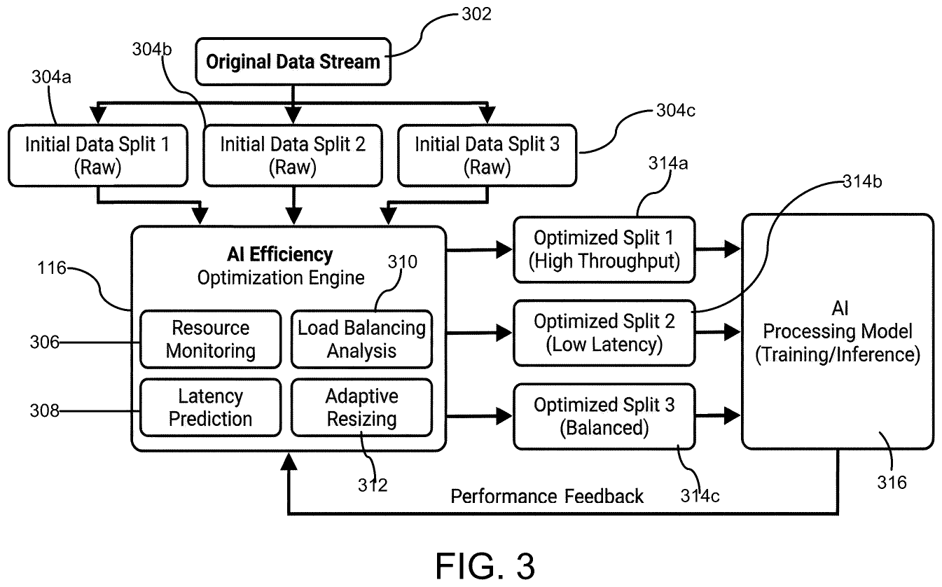

FIG. 3 illustrates a functional block diagram showing artificial intelligence driven data split efficiency optimization process performed in the multi-path secure data transmission system of the present invention, in accordance with the disclosed architecture. As shown in FIG. 3, for the artificial intelligence driven data split efficiency optimization process 300, an original data stream 302 comprising application layer data generated by an application executing on the transmitting device is divided into a plurality of raw data splits, including initial data split 304a, initial data split 304b, and initial data split 304c. The initial data splits may represent preliminary fragmentation of the original data stream prior to optimization and can be equal or unequal in size.

The initial data splits 304a-304c are provided to the artificial intelligence (AI) efficiency optimization engine 116. The artificial intelligence (AI) efficiency optimization engine 116 comprises one or more analytic and decision-making components configured to evaluate system and network conditions and to optimize processing of the data. In the illustrated embodiment, the artificial intelligence (AI) efficiency optimization engine 116 includes a resource monitoring module 306, a latency prediction module 308, a load balancing analysis module 310, and an adaptive resizing module 312.

The resource monitoring module 306 is configured to monitor available system and network resources, including processor utilization, memory availability, and network interface capacity. The resource monitoring module 306 continuously tracks the available computational resources (i.e., CPU, GPU, memory, and network bandwidth). The resource monitoring module 306 prevents bottlenecks by ensuring no single node is overwhelmed while others are idle. The latency prediction module 308 is configured to predict expected transmission latency for each available network path based on real-time and historical performance data. The latency prediction module 308 uses historical performance data to forecast how long a specific data split will take to process. The latency prediction module 308 proactively identifies splits that might cause delays and flags them for optimization before they enter the main model. The load balancing analysis module 310 is configured to evaluate how data splits should be distributed across multiple paths to optimize throughput and reliability. The load balancing module 310 evaluates the volume and complexity of incoming data packets against the current queue depth of the processing model. The load balancing module 310 distributes the workload evenly across available processing pathways. The adaptive resizing module 312 is configured to dynamically adjust the size and composition of data splits based on the outputs of the other modules. The adaptive resizing module 312 physically alters the size of the data batches (i.e., splits). If latency is high, it may create smaller, faster moving splits; if throughput is low, it may batch data into larger chunks. The adaptive latency module 312 adjusts the “granularity” of the data to match the optimal operating window of the main AI model.

Based on the analysis of the artificial intelligence (AI) efficiency optimization engine 116, the initial data splits are transformed into optimized data splits. As shown, the optimization process produces an optimized split 314a configured for high throughput, an optimized split 314b configured for low latency, and an optimized split 314c configured to provide a balanced tradeoff between throughput and latency. The number, size, and characteristics of the optimized splits may vary dynamically depending on operating conditions.

The optimized splits 314a-314c are provided to an artificial intelligence processing model/the artificial intelligence (AI) efficiency algorithm 316. The artificial intelligence processing model 316 may perform training using the optimized data splits. The artificial intelligence (AI) efficiency algorithm 316 may represent a machine learning model executing locally on the device or remotely on a server or edge computing node such as the artificial intelligence (AI) efficiency optimization engine 116.

Performance feedback generated by the artificial intelligence processing model 316 is transmitted back to the artificial intelligence (AI) efficiency optimization engine 116. The performance feedback (i.e., closed-loop feedback) can include processing latency, throughput, error rates, or other metrics indicative of processing efficiency and enables the artificial intelligence (AI) efficiency optimization engine 116 to continuously refine the optimization decisions thereof in a closed-loop manner. If the model detects a slowdown, the optimization engine 116 adjusts its logic for the next batch of splits immediately. This feedback loop sends performance metrics (i.e., inference time, queue depth) back to the optimization engine 116 to adjust logic for the next batch immediately using the previous batch's inference time and/or queue depth. The result is a system that self-corrects. Rather than static data pipelines that clog under pressure, this model ‘breathes’ with the workload - expanding and contracting data splits to maintain peak efficiency.

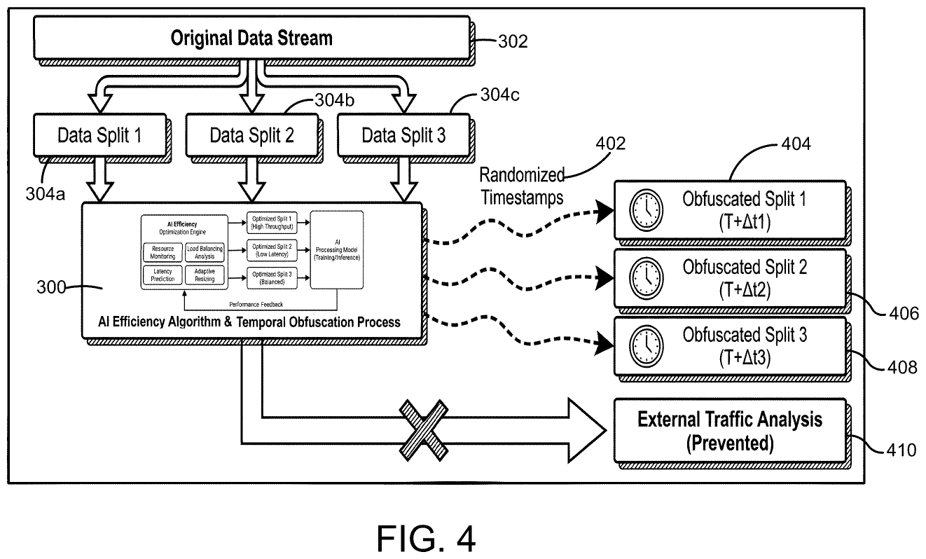

FIG. 4 illustrates a functional block diagram showing artificial intelligence driven temporal obfuscation and timestamp randomization applied to data splits in accordance with the disclosed structure. As shown in FIG. 4, an original data stream 302 is divided into a plurality of data splits, including data split 304a, data split 304b, and data split 304c. The data splits represent fragmented portions of the original data stream and can be equal or unequal in size.

The data splits 304a through 304c are provided to the artificial intelligence (AI) efficiency algorithm and temporal obfuscation process 300 of FIG. 3. The artificial intelligence (AI) efficiency algorithm and temporal obfuscation process 300 is configured to apply artificial intelligence based analysis to determine timing offsets and obfuscation parameters for each data split, as described in FIG. 3.

The artificial intelligence (AI) efficiency algorithm and temporal obfuscation process 300 is configured to generate a plurality of randomized timestamps 402 for each individual data split. The randomized timestamps provide temporal offsets relative to an original transmission time T of the original data stream 302. As shown, obfuscated split 1 404 is assigned a timestamp of T plus Δt1, obfuscated split 2 406 is assigned a timestamp of T plus Δt2, and obfuscated split 3 408 is assigned a timestamp of T plus Δt3. The timing offsets Δt1, Δt2, and Δt3 can be dynamically determined and may vary for each transmission instance.

The obfuscated splits 404, 406, and 408 are transmitted as independent packet streams across one or more network paths. It should be noted that by randomizing the timestamps of individual data splits, chronological correlation between the splits is disrupted.

FIG. 4 further illustrates that external traffic analysis 410 is prevented or substantially impeded. As the obfuscated splits 404, 406, and 408 are transmitted with randomized timing and can traverse different physical network paths, an external observer fails to determine which fragments belong to the same original data stream or to reconstruct the original ordering based on arrival times.

In operation, the temporal obfuscation illustrated in FIG. 4 operates in conjunction with the multipath fragmentation and transmission mechanisms described with respect to FIGS. 1 through 3. The fragmenting data across multiple paths and applying timestamp randomization provide security by increasing resistance to interception, correlation, and traffic pattern analysis.

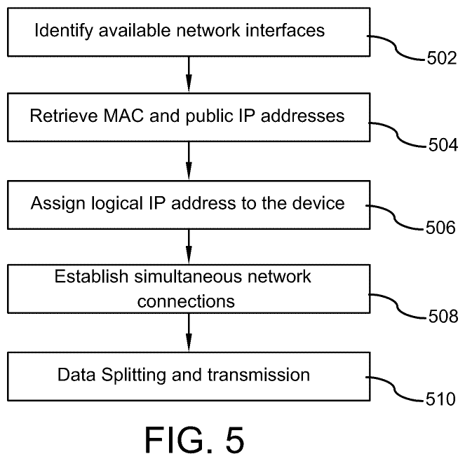

FIG. 5 illustrates a flowchart showing steps for establishing multipath connectivity and initiating secure multi-path data transmission between devices using the multi-path secure data transmission system of the present invention. Initially, available physical network interfaces on the transmitting device and the receiving device are identified (Step 502). The physical network interfaces can include, without limitation, Wi-Fi interfaces, cellular interfaces, Ethernet interfaces, Bluetooth interfaces, near-field communication interfaces, and other wired or wireless communication interfaces.

Then, media access control addresses and public IP addresses associated with the identified physical network interfaces are retrieved (Step 504). The addresses can be obtained from network database or through interrogation of the operating system and network drivers.

Thereafter, a logical IP address is assigned to the devices (such as transmitting device) (Step 506). The logical IP address serves as a virtual private address that functions as a unified communication endpoint for application layer communications.

At step 508, simultaneous network connections are established across the identified physical network interfaces between the transmitting device and the receiving device. Each connection can be associated with a different public IP address and can be maintained concurrently.

Finally, the data splitting and transmission of the application layer data stream is performed (Step 510). Application layer data is fragmented into a plurality of independent data splits and are transmitted concurrently across the established network connections as described in FIGS. 3 and 4.

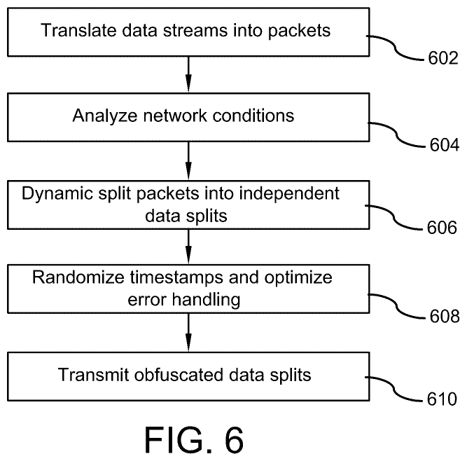

FIG. 6 illustrates a flowchart showing steps for artificial intelligence driven data splitting and temporal obfuscation in accordance with the disclosed structure. Initially, data streams are translated into packets (Step 602). Application layer data generated by an application executing on the transmitting device is converted into a plurality of data packets by the multipath and fragmentation engine. Each packet can include payload data and associated header information used for subsequent fragmentation, sequencing, and reassembly.

Then, the transmitting device or artificial intelligence (AI) efficiency optimization engine collects real-time and historical performance metrics associated with each available physical network interface (Step 604). Such metrics can include, without limitation, round-trip time, latency variation, available bandwidth, packet loss rate, congestion level, and interface stability.

At step 606, packets are dynamically split into independent data splits. Based on the analyzed network conditions, the artificial intelligence (AI) efficiency optimization engine determines a fragmentation ratio and divides each packet into multiple data splits. The data splits can be of equal or unequal size and can include sequence identifiers, fragment identifiers, and error correction metadata. The fragmentation ratio can be continuously adjusted as network conditions change.

Thereafter, timestamps associated with individual data splits are randomized and error handling parameters are optimized (Step 608). Timestamp randomization provides temporal offsets for each data split relative to an original transmission time, thereby obfuscating chronological relationships between fragments. This prevents attackers from easily reassembling intercepted fragments based on chronological arrival patterns. Error handling optimization can include selecting forward error correction schemes, configuring retransmission thresholds, and adjusting redundancy levels to maintain data integrity.

At step 610, obfuscated data splits are transmitted. The transmitting device concurrently transmits the independent data splits across multiple physical network interfaces and network paths. Because packets are split and sent via multiple public IP and MAC addresses across different network interfaces, a bad actor would be required to intercept multiple independent networks simultaneously to reconstruct the original message. Additionally, header randomization can be used to mask the fact that the fragments belong to the same session, preventing ‘traffic analysis’ by adversaries.

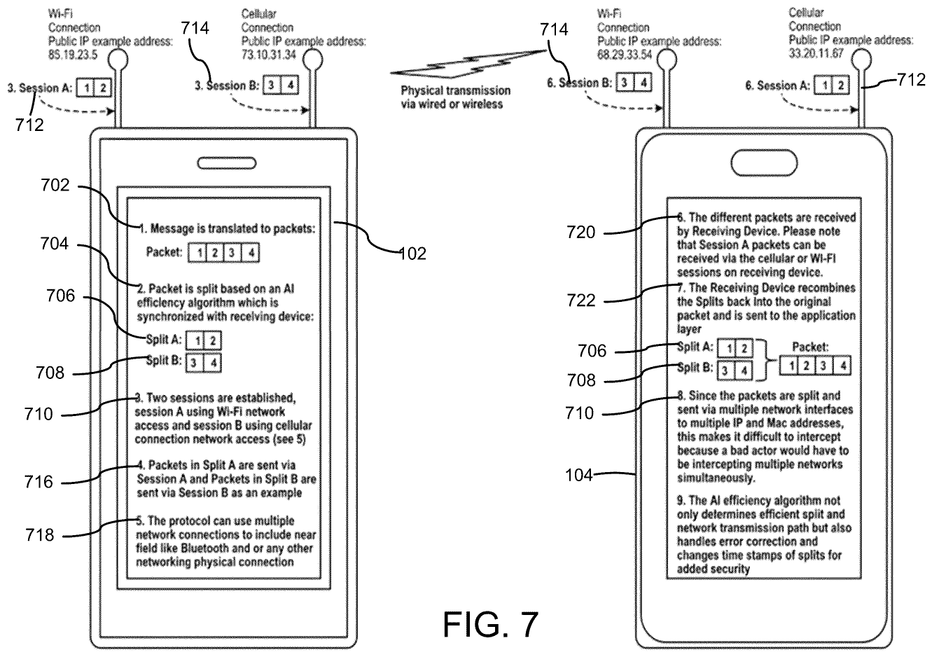

FIG. 7 illustrates a functional sequence diagram showing multipath data transmission and reassembly process between the transmitting device and the receiving device in accordance with the one embodiment of the present invention. As shown in FIG. 7, the transmitting device 102 communicates with the receiving device 104 using a plurality of physical network interfaces, including a Wi-Fi connection 712 and a cellular connection 714. Each connection is associated with a distinct public IP address, thereby providing independent network paths between the devices.

An application layer message is generated at the transmitting device 102 and is translated into a plurality of packets (Step 702). In the present embodiment, the message is converted into a packet sequence comprising packet portions identified as elements 1, 2, 3, and 4.

Then, the packet sequence is processed by the multipath and fragmentation engine operating under control of the artificial intelligence (AI) efficiency algorithm (AI model) synchronized with the receiving device 104 (Step 704).

Thereafter, the packet sequence is divided into a plurality of data splits (Step 706). In the present embodiment, a first data split (706), identified as Split A, includes packet portions 1 and 2, and a second data split (708), identified as Split B, includes packet portions 3 and 4. The number and composition of splits may vary dynamically.

Then, the data splits are transmitted concurrently over the established sessions by the transmitting device 102 (Step 710). Data split A is transmitted via the Wi-Fi session and data split B is transmitted via the cellular session. Each data split is encapsulated as an independent IP packet stream and transmitted using a different public IP address.

At step 716, packets associated with Split A 706 are transmitted via the first session 712 and packets associated with Split B 708 are transmitted via the second session 714. In the embodiment shown, Split A is transmitted over the Wi-Fi session and Split B is transmitted over the cellular session. The assignment of splits to sessions is dynamically determined by the artificial intelligence (AI) efficiency algorithm and may vary based on real-time network conditions, including bandwidth availability, latency, congestion, and reliability of each physical network interface.

At step 718, the system 100 may utilize additional network connections beyond Wi-Fi and cellular, including near-field or short-range communication technologies such as Bluetooth, peer-to-peer wireless connections, wired Ethernet connections, or other available physical networking interfaces.

The receiving device 104 receives the fragmented data splits (Step 720). In some embodiments, packets associated with a given split may arrive via either the Wi-Fi interface or the cellular interface of the receiving device, providing asymmetric reception logic and additional routing unpredictability. The system allows for flexibility where the first session fragments can be received via either the cellular or Wi-Fi sessions on the receiving device, regardless of how they were originally dispatched, adding another layer of routing unpredictability.

At step 722, the receiving device 104 recombines the received data splits 706, 708 into the original packet sequence. The multipath and fragmentation engine at the receiving device extracts the packet portions from the splits, orders the packet portions according to sequence metadata, and reconstructs the original packet comprising elements 1, 2, 3, and 4. The reconstructed packet is then delivered to the application layer.

At step 724, on the receiving side, the system benefits from the fact that data splits were transmitted across multiple public IP addresses and MAC addresses. As a result, interception is substantially more difficult because an unauthorized party would be required to intercept multiple independent networks simultaneously to reconstruct the original message.

The artificial intelligence model not only determines optimal fragmentation and path selection but also performs error correction and dynamically modifies timestamps associated with data splits to provide temporal obfuscation and added security. This prevents attackers from easily reassembling intercepted fragments based on chronological arrival patterns.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “data communication system”, “multi-path secure data transmission system”, “secure data transmission system”, and “system” are interchangeable and refer to the multi-path secure data transmission system 100 of the present invention.

Notwithstanding the forgoing, the multi-path secure data transmission system 100 of the present invention can be of any suitable configuration as is known in the art without affecting the overall concept of the invention, provided that it accomplishes the above stated objectives. One of ordinary skill in the art will appreciate that the multi-path secure data transmission system 100 shown in the FIGS. are for illustrative purposes only, and that many other configurations of the multi-path secure data transmission system 100 are well within the scope of the present disclosure. Although the dimensions of the multi-path secure data transmission system 100 are important design parameters for user convenience, the multi-path secure data transmission system 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-path secure data transmission system comprising;
a transmitting device;
a receiving device;
a public network;
a first multipath and fragmentation engine;
a first command software;
a second multipath and fragmentation engine;
a second command software; and
an AI optimization engine;
wherein said transmitting device and said receiving device are configured to communicate across said public network;
wherein said transmitting device comprises said first command software and said first multipath and fragmentation engine;
wherein said receiving device comprises said second command software and said second multipath and fragmentation engine;
wherein said AI optimization engine is communicatively coupled between said transmitting device and said receiving device;
wherein said first multipath and fragmentation engine of said transmitting device is configured to fragment outgoing data into multiple independent data splits and distribute said multiple independent data splits across multiple physical network interfaces;
wherein said transmitting device comprises a first Wi-Fi interface and a first cellular interface;
wherein each of said first Wi-Fi interface and said first cellular interface associated with a distinct physical network connection and a corresponding public IP address for secure transmission with said receiving device;
wherein said second multipath and fragmentation engine of said receiving device is configured to receive said multiple independent data splits from said multiple physical network interfaces and to reassemble said multiple independent data splits into an original data stream; and
further wherein said receiving device comprises a second Wi-Fi interface and a second cellular interface for providing independent connectivity to said public network.

2. The multi-path secure data transmission system of claim 1, wherein said AI optimization engine is configured to analyze real-time network conditions and device operating conditions selected from the group consisting of latency, bandwidth, packet loss, jitter, processor utilization, memory availability, and application processing feedback.

3. The multi-path secure data transmission system of claim 2, wherein said AI optimization engine is configured to determine conditions selected from the group consisting of fragmentation ratios, transmission paths, and timing offsets for individual said fragmented data splits.

4. The multi-path secure data transmission system of claim 3, wherein said AI optimization engine is further configured to apply temporal obfuscation by modifying at least one of timestamps and headers associated with individual said multiple independent data splits prior to transmission and to provide synchronization information to both said transmitting device and said receiving device to enable coordinated reassembly of said multiple independent data splits.

5. The multi-path secure data transmission system of claim 4, wherein said public network comprises one or more external networks selected from the group consisting of an Internet, a carrier core network, and a packet-switched network over which said multiple independent data splits are transmitted.

6. The multi-path secure data transmission system of claim 5, wherein each of said transmitting device and said receiving device are configured as programmable computing devices to execute instructions, wherein said programmable computing devices selected from the group consisting of a smartphone, a tablet computer, a laptop computer, a desktop computer, a server, a gateway, a router, an embedded system, an Internet of Things device, and an edge computing node.

7. The multi-path secure data transmission system of claim 6, wherein said transmitting device comprises an application layer including one or more software applications for executing on said transmitting device to generate, transmit, receive, and consume application layer data.

8. The multi-path secure data transmission system of claim 7, wherein said application layer comprises one or more selected from the group consisting of a web browser, a messaging application, a voice-over-IP application, and a video streaming application.

9. The multi-path secure data transmission system of claim 8, wherein said application layer is configured to interface with a logical IP layer and comprises a virtual logical IP address assigned to said transmitting device as a unified communication endpoint.

10. The multi-path secure data transmission system of claim 9, wherein said application layer data generated by said application layer is provided to said logical IP layer and forwarded to a multipath transport engine for fragmentation, scheduling, and transmission.

11. The multi-path secure data transmission system of claim 10, wherein reassembled said application layer data received by said multipath transport engine is delivered through said logical IP layer to said application layer in its original format.

12. The multi-path secure data transmission system of claim 11, wherein said logical IP layer is configured to assign and maintain a virtual private logical IP address for said transmitting device that serves as a unified communication endpoint.

13. The multi-path secure data transmission system of claim 12, wherein said logical IP layer is configured to decouple application layer sessions from physical network addressing.

14. A multi-path secure data transmission system comprising;
a transmitting device;
a receiving device;
a public network;
a first multipath and fragmentation engine;
a first command software;
a second multipath and fragmentation engine;
a second command software; and
an AI optimization engine;
wherein said transmitting device and said receiving device are configured to communicate across said public network;
wherein said transmitting device comprises said first command software and said first multipath and fragmentation engine;
wherein said receiving device comprises said second command software and said second multipath and fragmentation engine;
wherein said AI optimization engine is communicatively coupled between said transmitting device and said receiving device;
wherein said first multipath and fragmentation engine of said transmitting device is configured to fragment outgoing data into multiple independent data splits and distribute said multiple independent data splits across multiple physical network interfaces;
wherein said transmitting device comprises a first Wi-Fi interface and a first cellular interface;
wherein each of said first Wi-Fi interface and said first cellular interface associated with a distinct physical network connection and a corresponding public IP address for secure transmission with said receiving device;
wherein said second multipath and fragmentation engine of said receiving device is configured to receive said multiple independent data splits from said multiple physical network interfaces and to reassemble said multiple independent data splits into an original data stream;
wherein said receiving device comprises a second Wi-Fi interface and a second cellular interface for providing independent connectivity to said public network; and
further wherein said AI optimization engine is further configured to apply temporal obfuscation by modifying at least one of timestamps and headers associated with individual said multiple independent data splits prior to transmission and to provide synchronization information to both said transmitting device and said receiving device to enable coordinated reassembly of said multiple independent data splits.

15. The multi-path secure data transmission system of claim 14, wherein said transmitting device comprises an application layer including one or more software applications for executing on said transmitting device to generate, transmit, receive, and consume application layer data.

16. The multi-path secure data transmission system of claim 15, wherein said application layer comprises one or more selected from the group consisting of a web browser, a messaging application, a voice-over-IP application, and a video streaming application.

17. The multi-path secure data transmission system of claim 16, wherein said application layer is configured to interface with a logical IP layer and comprises a virtual logical IP address assigned to said transmitting device as a unified communication endpoint.

18. A multi-path secure data transmission system comprising;
a transmitting device;
a receiving device;
a public network;
a first multipath and fragmentation engine;
a first command software;
a second multipath and fragmentation engine;
a second command software; and
an AI optimization engine;
wherein said transmitting device and said receiving device are configured to communicate across said public network;
wherein said transmitting device comprises said first command software and said first multipath and fragmentation engine;
wherein said receiving device comprises said second command software and said second multipath and fragmentation engine;
wherein said AI optimization engine is communicatively coupled between said transmitting device and said receiving device;
wherein said first multipath and fragmentation engine of said transmitting device is configured to fragment outgoing data into multiple independent data splits and distribute said multiple independent data splits across multiple physical network interfaces;
wherein said transmitting device comprises a first Wi-Fi interface and a first cellular interface;
wherein each of said first Wi-Fi interface and said first cellular interface associated with a distinct physical network connection and a corresponding public IP address for secure transmission with said receiving device;
wherein said second multipath and fragmentation engine of said receiving device is configured to receive said multiple independent data splits from said multiple physical network interfaces and to reassemble said multiple independent data splits into an original data stream;
wherein said receiving device comprises a second Wi-Fi interface and a second cellular interface for providing independent connectivity to said public network;
wherein said AI optimization engine is further configured to apply temporal obfuscation by modifying at least one of timestamps and headers associated with individual said multiple independent data splits prior to transmission and to provide synchronization information to both said transmitting device and said receiving device to enable coordinated reassembly of said multiple independent data splits; and
further wherein said transmitting device comprises an application layer including one or more software applications for executing on said transmitting device to generate, transmit, receive, and consume application layer data.

19. The multi-path secure data transmission system of claim 18, wherein said application layer comprises one or more selected from the group consisting of a web browser, a messaging application, a voice-over-IP application, and a video streaming application, and further wherein said application layer is configured to interface with a logical IP layer and comprises a virtual logical IP address assigned to said transmitting device as a unified communication endpoint.

20. The multi-path secure data transmission system of claim 19, wherein said application layer data generated by said application layer is provided to said logical IP layer and forwarded to a multipath transport engine for fragmentation, scheduling, and transmission, and wherein reassembled said application layer data received by said multipath transport engine is delivered through said logical IP layer to said application layer in its original format.
